(19) United States
(12) Patent Application Publication
(10) Pub. No.: US 2021/0252524 A1
(43) Pub. Date: Aug. 19, 2021

(54) DEVICE FOR PURIFYING A GASEOUS MEDIUM LOADED WITH PARTICLES

(71) Applicants: Daniel TEBOUL, ISSY LES MOULINEAUX (FR); Emrah ALTUGLU, LA PLAINE SAINT DENIS (FR)

(72) Inventors: Daniel TEBOUL, ISSY LES MOULINEAUX (FR); Emrah ALTUGLU, LA PLAINE SAINT DENIS (FR)

(21) Appl. No.: 17/251,588

(22) PCT Filed: Jun. 13, 2019
(86) PCT No.: PCT/FR2019/051436

§ 371 Date: Dec. 11, 2020

(30) Foreign Application Priority Data
Jun. 22, 2018 (FR) 1855583

(51) Int. Cl. B03C 3/41; B03C 3/82; B03C 3/15; B03C 3/49; B03C 3/70; F01N 3/24

(52) U.S. Cl. CPC B03C 3/41; B03C 3/82; B03C 3/15; B03C 2201/30; B03C 3/70; F01N 3/24; B03C 2201/10; B03C 3/49

(57) ABSTRACT

Disclosed is a device for purifying a gaseous medium loaded with particles including a shell closed at the ends thereof by an end plate protected by a disjoined shell, an electrostatic filtration chamber having a passage for the gaseous medium loaded with particles; the chamber including an emissive structure including serrated plates forming tips directed towards a collecting structure on either side of the emissive structure and designed to trap the particles contained in the gaseous medium; the end plate and the shell are each brought to a different predetermined potential so as to create an electric repulsion field in the vicinity of the end plate, directed towards the passage.

### CROSS-REFERENCE TO RELATED APPLICATIONS

This application is the U.S. national phase of International Application No. PCT/FR2019/051436 filed Jun. 13, 2019 which designated the U.S. and claims priority to FR 1855583 filed Jun. 22, 2018, the entire contents of each of which are hereby incorporated by reference.

### BACKGROUND OF THE INVENTION

### Field of the Invention

The present invention relates to a device for purifying a gaseous medium laden with particles of all kinds, such as particles of dust, organic particles in suspension in exhaust gases of all kinds and in particular from industrial boilers, from chimneys equipping industrial ovens, from diesel engines, etc.

### Description of the Related Art

The applicant has already proposed this type of device for purifying a gaseous medium laden with particles, more particularly for the exhaust gases of an internal combustion engine (see in particular patent application WO 01/19525).

This treatment device comprises a corona-effect electrofilter or electrofilters comprising a longitudinal casing of cylindrical shape in which extends a longitudinal passage for the gases to treat, an emitting structure extending longitudinally at the center of the passage and a collecting structure (formed by stainless steel metal mesh, designated cartridge) extending longitudinally between the passage and the casing and comprising a plurality of cavities forming sites for trapping the particles contained in the gaseous medium, the emitting structure comprising a plurality of serrated plates disposed transversely to the longitudinal direction and forming points directed towards collecting structure. These serrated plates are carried by a rigid shaft connected to a circuit supplying a stabilized high voltage and which is carried at each of its ends by an insulator protected by a bell-shaped cover (bell). The insulators, formed from vitrified ceramic (dielectric) each comprise an end disk shutting off the openings of the casing at both its longitudinal ends.

This device is entirely satisfactory, but it can occur that particles, such as charged soot particles, come to be deposited on the insulators in particular at the location of the end disk thereby forming a layer of soot responsible for the formation of electric arcs reducing the effectiveness of the filtration device and sometimes required the device to be stopped.

### SUMMARY OF THE INVENTION

The present invention is directed to providing a device of the same type, having improved performance in particular in terms of effectiveness and furthermore leading to other advantages.

It is also directed to making a purification device which is convenient and easy to maintain.

To that end it provides a purification device for purifying a gaseous medium laden with particles comprising:
a casing closed at its ends by an end plate protected by a separate shell surrounding one of the ends of an emitting structure and having a cavity oriented towards said end plate, said shell being disposed inside said casing;
an electrostatic filtration chamber having a passage for the gaseous medium laden with particles extending within said casing between an inlet for that medium into the chamber and an outlet therefrom; said chamber comprising
   an emitting structure comprising serrated plates forming points directed towards a collecting structure; and
   said collecting structure being on opposite sides of said emitting structure and configured to trap the particles contained in the gaseous medium;

characterized in that said end plate and said shell are each brought to a different predetermined potential so as to create a repulsive electric field in the neighborhood of said end plate, directed towards said passage.

The device according to the invention possesses, at each end of the casing, an end plate/shell assembly which, by virtue of its arrangement and the potential difference between the end plate and the shell, makes it possible to create a repulsive electric field in the neighborhood of each end plate. This repulsive electric field is directed towards the passage of the electrostatic filtration chamber, the particles are thus pushed away from the end plate and they are directed towards the passage of the electrostatic filtration chamber.

It will be noted that, in contrast to the aforementioned prior device, the purification device according to the invention makes it possible to avoid the deposit and the agglomeration of soot particles on the end plates; the formation of electric arcs on the end plates, responsible in particular for the drop in effectiveness of the purification device, is thus avoided.

Furthermore, these provisions make it possible to produce a device that is easy to maintain and which in addition makes it possible to reduce the maintenance costs of the purification device since this avoids regularly dismantling the purification device to clean the end plates.

According to advantageous features of the device according to the invention:
said end plate is brought to a zero potential and said shell is brought to a negative potential comprised between −10 KV and −25 KV;
the potential difference between said end plate and said shell is comprised between −35 KV and 0 KV;
said shell has the shape of a bell formed by a circular wall closed at one of its ends by a roof;
said casing is of circular shape and said end plate is formed by an end disk of a cylindrical component comprising a first tubular part and a second tubular part projecting from said end disk, said first tubular part and said second tubular part having an opposite relationship to each other relative to said end disk, the first tubular part being disposed inside said casing and the second tubular part being disposed outside said casing, said end disk further comprising a central opening forming an internal passage in said cylindrical component between said first tubular part and said second tubular part;
said first tubular part enters said shell to form a chicane for the stream of gas;
said serrated plates are carried by a central shaft passing via said internal passage of said cylindrical component, said central shaft being connected to a circuit supplying a stabilized high voltage and being carried at each of its ends by an insulator surrounding said central shaft, said insulator being disposed in said second tubular part of said cylindrical component to electrically protect said cylindrical component from said central shaft;
said shell is fastened to said central shaft and said shell is brought to the same said stabilized voltage as said central shaft;
said stabilized voltage of said central shaft is negative preferably between −10 KV and −25 KV;
said emitting structure comprises at least one electrically conducting filament able to be brought to the potential of said emitting structure, said at least one filament connecting together at least one said point of at least two said serrated plates;
said at least one filament connects a said point of all said serrated plates;
said serrated plates each comprise at least one opening via which passes said at least one conducting filament;
said at least one filament is electrically connected to a central shaft carrying said serrated plates and being connected to a circuit supplying a stabilized high voltage;
said emitting structure comprises several said parallel filaments surrounding said emitting structure in a circular disposition;
said serrated plates comprise as many said openings as said filaments;
said serrated plates are star-shaped, that is to say with a circular central support provided at its periphery with triangular arms of which the end forms said points;
said serrated plates alternate with perforated washers of propeller shape;
said inlet and said outlet each form an angle with the axis of said passage generating a cyclonic effect in said passage;
said inlet and said outlet are diametrically opposite; and
said collecting structure extends to each of said end plates of said casing.

The invention also provides for the use of a purification device as defined above for purifying exhaust gases of an internal combustion engine.

According to a second aspect, the invention is directed to providing a device having improved performance in particular in terms of effectiveness, avoiding as much as possible the deposit of particles on the points of the emitting structure the effect of which is to deteriorate performance, and furthermore leading to other advantages.

To that end the invention provides a device for purifying a gaseous medium laden with particles comprising:
a casing;
an electrostatic filtration chamber having a passage for the gaseous medium laden with particles extending within said casing between an inlet for that medium into the chamber and an outlet therefrom; said chamber comprising
   an emitting structure arranged in the passage and comprising serrated plates forming points directed towards a collecting structure; and
   a collecting structure configured to trap the particles contained in the gaseous medium, that is located on opposite sides of said emitting structure;

characterized in that said emitting structure comprises at least one electrically conducting filament able to be brought to the potential of said emitting structure, said at least one filament connecting together at least one said point of at least two said serrated plates.

The device according to the invention makes it possible, by virtue of the filament which is brought to the potential of the emitting structure between two points, to form a conducting electrical bridge connecting the two points. This filament very simply produces a corona effect (ionization of gas when the electric field reaches a breakdown gradient) that is additional to the corona effect already produced by the points of the serrated plates, so improving the effectiveness of the purification device.

It is furthermore to be observed that the electric current passing through the filament dissipates energy in the form of heat (Joule effect) and makes the filament incandescent so burning the particles which come to be deposited on the points. The deposit and the agglomeration of particles on the points of the emitting structure is thus avoided so making it possible to keep the points clean generating an optimum corona effect.

Furthermore, these provisions make it possible to produce a device that is easy to maintain and which in addition makes it possible to reduce the maintenance costs of the purification device since this avoids regularly cleaning the points of the emitting structure.

According to advantageous features of implementation:
said at least one filament has a predetermined diameter, preferably 0.5 mm;
said serrated plates each comprise at least one opening via which passes said at least one conducting filament;
said at least one opening of the serrated plates is located at a predetermined distance from said point comprised between 0.5 mm and 2 mm, preferably 1 mm;
said passage extends longitudinally and said serrated plates are transversely disposed and are carried by a central shaft connected to a stabilized high voltage circuit, each of the ends of said at least one filament being electrically connected to said central shaft;
said serrated plates are star-shaped, that is to say with a circular central support provided at its periphery with arms of triangular shape of which the end forms said points, said arms each comprising at the location of the points a said opening able to receive a said filament;
said serrated plates alternate with perforated crowns or washers, of propeller shape each comprising at least one opening via which passes said at least one filament;
said at least one opening of the perforated crowns or washers is located at a predetermined distance from said point comprised between 0.5 mm and 2 mm, preferably 1 mm;
said at least one filament is a filament of tungsten or of stainless steel;
said serrated plates all comprise the same number of said points and said emitting structure comprises as many filaments as said points per serrated plate;
said emitting structure comprises several said parallel filaments surrounding said central shaft;
said serrated plates comprise as many said openings as said filaments;
said casing is closed at its ends by an end plate protected by a separate shell surrounding one of the ends of said emitting structure and having a cavity oriented towards said end plate, said shell being disposed inside said casing, said end plate and said shell each being brought to a different predetermined potential so as to create a repulsive electric field in the vicinity of said end plate, directed towards said passage;
said shell is brought to the same predetermined potential as said emitting structure;
said inlet and said outlet each form an angle with the axis of said passage generating a cyclonic effect in said passage; and
said inlet and said outlet are diametrically opposite.

### BRIEF DESCRIPTION OF THE DRAWINGS

The disclosure of the invention will now be continued with the detailed description of an embodiment, given below by way of non-limiting example, with reference to the accompanying drawings. In these:

FIG. 1 is a perspective view of a purification device for purifying a gaseous medium, in accordance with the present invention;

FIG. 2 is the section view on II-II of FIG. 1;

FIG. 3 is a diagrammatic representation of FIG. 2 viewed from the bottom left of the device;

FIG. 4 is an exploded view, of the main members of the purification device of FIG. 1;

FIG. 5 is a diagrammatic representation of a front view of one of the star-shaped serrated plates shown in FIGS. 2 to 4;

FIG. 6 is a diagrammatic representation of a front view of one of the perforated washers of propeller shape shown in FIGS. 2 to 4;

FIGS. 7 and 8 are respectively perspective and plan views of the cylindrical component shown in FIGS. 2 to 4; and

FIGS. 9 and 10 are respectively perspective and plan views of the shell shown in FIGS. 2 to 4.

### DESCRIPTION OF THE PREFERRED EMBODIMENTS

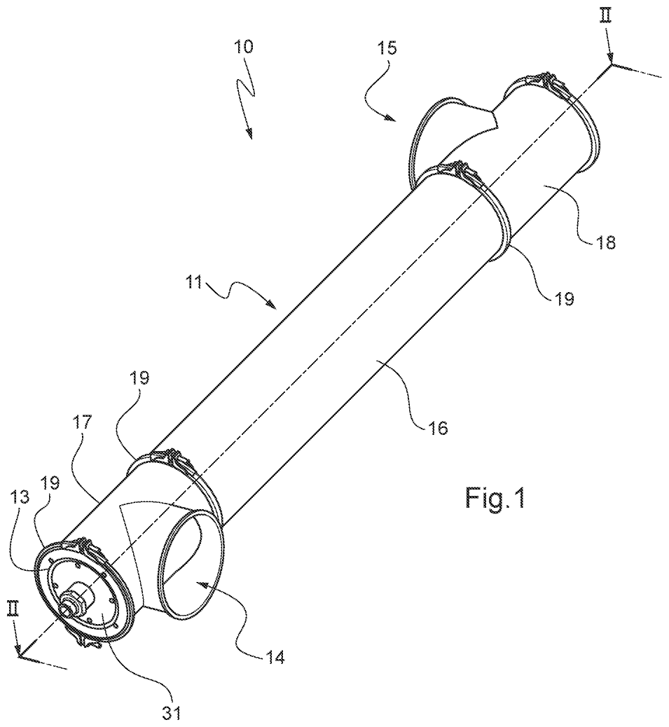

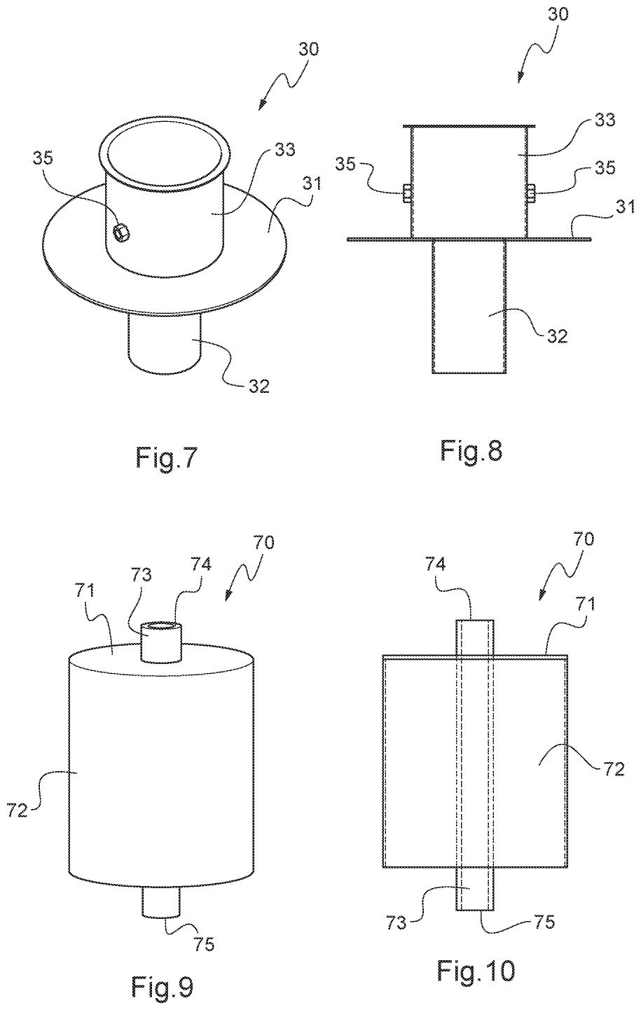

The purification device 10 for purifying a gaseous medium laden with particles that is the subject of the embodiment in FIGS. 1 to 10 is used for the purification of the exhaust gases of an internal combustion engine.

In the interest of revealing its characteristic members, this purification device has been shown very diagrammatically in some Figures.

This purification device 10 comprises in particular a longitudinal casing 11 in which is accommodated a corona effect electrofilter of which the operating principle is known from the prior art and in particular from patent application WO 01/19525.

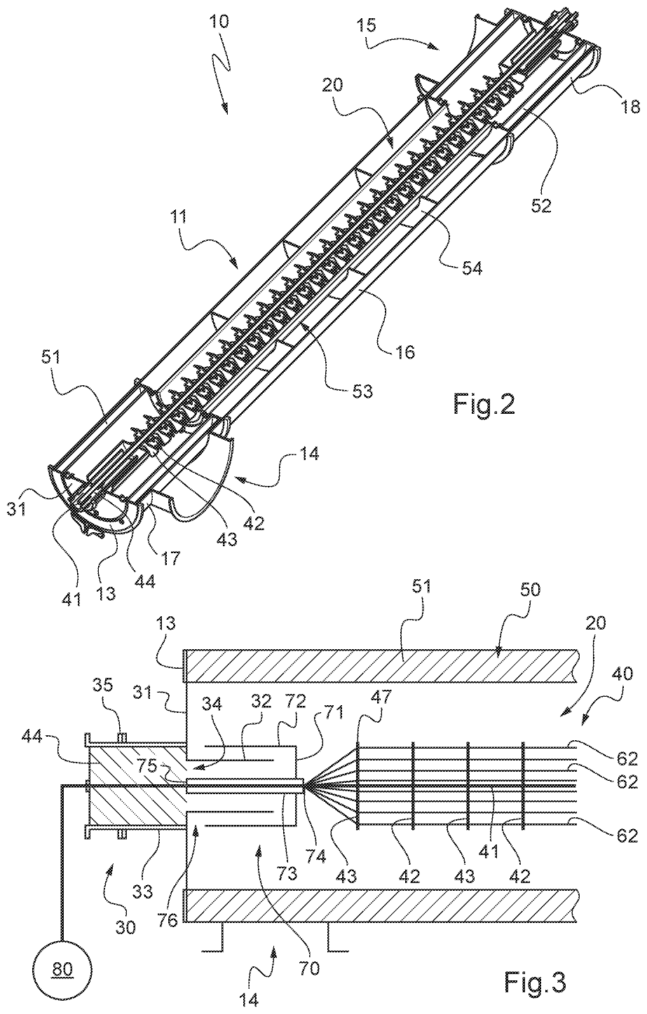

As illustrated in FIG. 1, the casing 11 is closed at its ends by an end plate. The end plate is formed here by an end disk 31 (of a cylindrical component 30 also shown in FIGS. 2, 3, 7 and 8) and by the ring 13.

Two diametrically opposite openings 14 and of 15 are formed in that casing 11 to enable the inlet and outlet of the gases from the casing 11.

The casing 11 is of circular shape here. It is formed here by three cylindrical cages 16, 17 assembled together. The central cylindrical cage 16 is disposed at the center and is assembled, at one of its ends, with the cylindrical cage 17 and at the opposite end with the cylindrical cage 18 by virtue of clamping collars 19.

The cylindrical cages 17 and 18 are identical. The opening 14 is formed in the cylindrical cage 17 and the opening 15 is formed in the cylindrical cage 18.

As illustrated in FIGS. 2 and 3, the purification device 10 also comprises an electrostatic filtration chamber 20 located in the casing 11.

This electrostatic filtration chamber 20 forms a longitudinal passage for the gaseous medium laden with particles between an inlet thereof and an outlet thereof.

The inlet of the electrostatic filtration chamber 20 by which the gaseous medium laden with particles enters is the opening 14 here. The outlet of the electrostatic filtration chamber 20 by which is discharged the gaseous medium cleared of its particles is the opening 15 here.

The inlet 14 and the outlet 15 each form an angle with the axis of the passage generating a cyclonic effect in the passage. The angle is ninety degrees here.

The gaseous medium laden with particles thus enters the purification device 10, in a direction substantially perpendicular to that of the flow in the chamber and comes out also in a direction perpendicular to that of the flow in the chamber.

The electrostatic filtration chamber 20 comprises an emitting structure 40 arranged in the passage and a collecting structure 50, on opposite sides of the emitting structure 40, configured to trap the particles contained in the medium.

The collecting structure 50 is formed from a cartridge made from a mesh of metal wire here surrounding the emitting structure 40. The mesh of metal wire is formed here by three meshes 51, 52 and 53 assembled so as to produce a homogenous mesh. The metal meshes 51, 52 and 53 are here of cylindrical shape and they delimit an internal space in which is arranged the emitting structure 40.

The three meshes 51, 52 and 53 comprise a plurality of cavities not shown in the Figures forming sites able to trap the particles contained in the medium laden with particles that passes through the passage.

Furthermore, each mesh 51, 52 and 53, by its chevron structure, makes it possible to facilitate the penetration of the particles into the thickness of the mesh.

Two identical metal meshes 51 and 52 are arranged respectively in the cylindrical cage 17 and in the cylindrical cage 18. These metal meshes 51 and 52 extend to the end plate and they form, at the location of the openings 14 and 15, a mechanical filter for the particles.

A central metal mesh 53 is arranged in the central cylindrical cage 16. The central metal mesh 53 comprises annular disks 54 serving as spacers. These annular disks 54 project from a central tube 55 comprised by the mesh 53.

As regards the emitting structure 40 at the center of the passage, this comprises serrated plates 42 carried by a central shaft 41 and which alternate with perforated washers 43.

The central shaft 41 extends axially and is carried at each of its ends by an insulator 44 surrounding the central shaft 41, and which is disposed in the cylindrical component 30 (FIG. 3).

The central shaft 41 is connected to a circuit 80 supplying a stabilized high voltage of the type comprising a converter supplying a stabilized high voltage here negative and comprised between 10 and 25 kV, with adjustment by a regulator.

The serrated plates 42 and the perforated washers 43 form metal emitting parts mounted on the central shaft 41. The serrated plates 42 and the perforated washers 43 are transversely disposed to the longitudinal direction of the passage.

A description will now be given in more detail with the aid of FIG. 5, of one of the serrated plates 42 shown in FIGS. 2 to 4, the other serrated plates 42 being identical to the serrated plate 42 which will be described hereinafter.

The serrated plate 42 is star-shaped here, that is to say with a circular central support 45 provided at its periphery with triangular arms 46 of which the end forms a point 47.

When the device 10 is assembled, these points 47 are directed towards the collecting structure 50, that is to say towards the metal meshes 51, 52 and 53 (FIGS. 2 and 3).

The circular central support 45 has a central opening 48 able to allow passage of the central shaft 41, as well as peripheral openings 49, which are eight in number here. The peripheral openings 49 are regularly spaced in a circular disposition around the central opening 48. The peripheral openings 49 make it possible to avoid back-pressure phenomena.

The triangular arms 46 are sixteen in number here and are arranged regularly around the circular central support 45. Each arm 46 comprises an opening 61, at the location of the point 47, configured to allow a conducting filament 62 to pass, as is explained in more detail hereinafter.

The diameter of each opening 61 is substantially equal to the diameter of the conducting filament 62 to enable its passage. Each opening 61 is located at a predetermined distance from the point 47, here the distance is comprised between 0.5 mm and 2 mm, preferably 1 mm.

As explained previously, the serrated plates 42 alternate with the perforated metal washers 43 which will now be described with the aid of FIG. 6. A single perforated washer 43 is shown in that Figure, the other metal washers 43 being identical to the metal washer 43 to be described.

The perforated washer 43 shown in FIG. 6 here has the same outside diameter as the serrated plate 42. The perforated washer 43 here takes the shape of a propeller comprising a ring 63 from which project blades 64, which are four in number here.

The ring 63 has a central opening 65 able to allow passage of the central shaft 41. Each blade 64 comprises openings 66, which are three in number here, able to allow passage of the filament 62 as explained in more detail hereinafter.

The diameter of each opening 66 is substantially equal to the diameter of the conducting wire to enable its passage. Furthermore, each opening 66 is located at a predetermined distance from the end of the blade 64, here the distance is comprised between 0.5 mm and 2 mm, preferably 1 mm.

The emitting structure 40 also comprises filaments 62 that are electrically conducting and able to be brought to the potential of the emitting structure 40.

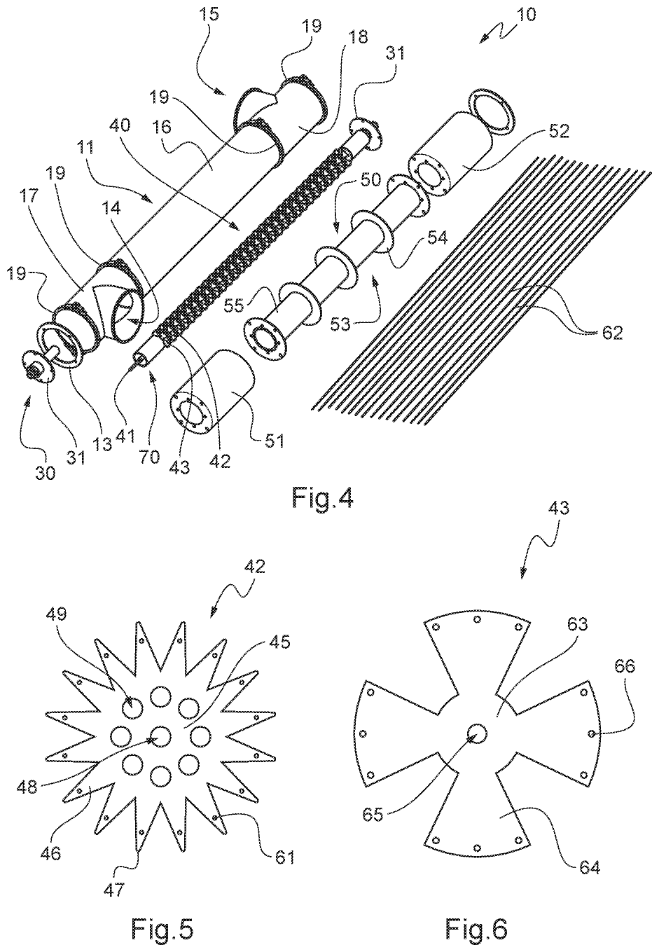

It will be noted that these filaments 62 are very fine and cannot be seen in the cross-section of FIG. 2. These filaments 62 can however be seen in FIGS. 3 and 4.

The emitting structure 40 here comprises sixteen filaments 62 (eight of which are shown in the cross-section of FIG. 3), i.e. as many filaments 62 as there are points 47 per serrated plate 42.

The filaments 62 are made from tungsten here, but may also be made from stainless steel and they have a predetermined diameter preferably of the order of 0.5 mm.

The filaments 62 are parallel. They extend longitudinally in the direction of the passage, parallel to the central shaft 41 and they surround the central shaft 41 in a circular disposition.

The filaments 62 connect together the points 47 of the serrated plates 42. Each filament 62 connects a point 47 of one serrated plate 42 to a point 47 of another serrated plate 42 in the manner of a bridge, this being the case between all the serrated plates 42 throughout the length of the central shaft 41.

The filaments 62 here pass via the openings 61 of the serrated plates 42. The filaments 62 are located at the location of the points 47.

To that end it will be noted that the serrated plates 42 comprise as many openings 61 as there are filaments 62, that is to say, here, sixteen openings 61 per serrated plate 42 and sixteen filaments 62.

It will also be noted that the serrated plates 42 comprise as many points 47 as there are filaments 62, that is to say, here, sixteen points 47 and sixteen filaments 62.

Regarding the arrangement of the filaments 62 relative to the perforated washers, it will be noted that some filaments 62 pass via the openings 66 of the perforated washers 43 and that other filaments 62 pass via the space between the blades 64.

A description will now be given in more detail of the arrangement of the filament 62 shown at the top of FIG. 3.

The end of the filament 62 is connected to the central shaft 41, the filament 62 then passes via the opening 66 (shown in FIG. 6) of the perforated washer 43 (the closest to the end disk 31), then by the opening 61 (shown in FIG. 5) of a first serrated plate 42 then it passes via the opening 66 (shown in FIG. 6) of a second perforated washer 43 then via the opening 61 (shown in FIG. 5) of a second serrated plate 42.

The filament 62 then continues its path in the same way (not shown in FIG. 3) to reach the last perforated washer 43 of the central shaft 41 (illustrated on the extreme right in FIG. 2) before being connected in the same way to the central shaft 41 by its other end.

It will be noted that the same applies for the other filaments 62 except that some filaments 62 do not pass via the openings 66 of the perforated washers 43 but within the space provided between the blades 64 (which can be seen in FIG. 6).

It will also be noted that alternatively the filaments 62 do not pass via the openings 66 of the perforated washers 43 but pass above the blades 64.

Each end of the filaments 62 is electrically connected to the central shaft 41. The filaments 62 are thus brought to the same voltage as the central shaft 41.

On use of the purification device 10, the filaments 62 produce a corona effect which is additional to the corona effect produced by the points 47 which enables better ionization of the gas passing in the passage and better collection of the particles.

Furthermore, the filaments 62 are passed through by a predetermined current able to make the filaments 62 incandescent. These latter burn the particles of soot which deposit on the points 47 of the serrated plates 42. The points 47 thus remain clean during the entire duration of use of the device 10, the corona effect is thus optimal for the entire duration of use of the device 10.

The casing 11 is closed at each of its ends by an end plate, here formed by an end disk 31 and by a ring 13, protected by a separate shell 70 disposed inside the casing 11 and which surrounds one of the ends of the emitting structure 40 (FIGS. 2 and 3).

A description will now be given of the left part of the device 10 diagrammatically represented in FIG. 3, the right part being identical to the left which will be described hereinafter.

The ring 13 is mounted on the end disk 31. It is held to the casing 11 by a clamping collar 19. The ring 13 and the collar 19 make it possible to dismantle the cylindrical component 30 easily to facilitate the cleaning of the filtration device 10.

A description will now be given, with the aid of FIGS. 3, 7 and 8, of the cylindrical part 30.

The cylindrical component 30 comprises the end disk 31, a first tubular part 32 and a second tubular part 33, opposite each other, and which project from the end disk 31.

The second tubular part 33 is disposed outside the casing 11 and the first tubular part 32 is disposed inside the casing 11.

The insulator 44, here of ceramic, is arranged inside the second tubular part 33. The insulator 44 carries and surrounds the central shaft 44. It serves to electrically protect the cylindrical component 30 from the central shaft 41 which is brought to a stabilized high voltage (FIG. 3).

The second tubular part further comprises two bolts 35 on the outside face which are connected here to the circuit ground and more specifically to earth (not shown).

The end disk 31 comprises a central opening 34 connecting the first tubular part 32 and the second tubular part 33 and forming an internal passage for the central shaft 41 between the first tubular part 32 and the second tubular part 33.

It will be noted that the end disk 31 has an outside diameter greater than the outside diameter of the first tubular part 32 and than the outside diameter of the second tubular part 33.

It will also be noted that the outside diameter of the first tubular part 32 is less than the outside diameter of the second tubular part 33.

A description will now be given of the shell 70, located substantially adjacent the opening 14, with reference to FIGS. 3, 9 and 10. The oppositely located shell 70 adjacent the opening 15 is identical to the shell which will now be described.

The shell 70 has the shape of a bell. It comprises a circular wall 72 closed at one of its ends by a roof 71 and comprises a central tube 73 able to receive the central shaft 41.

The roof 71 takes the form of a disk disposed transversely to the longitudinal direction of the passage and from which, in the direction of the passage towards the end disk 31, extends the circular longitudinally 72.

The roof 71 and the circular wall 72 delimit a cavity oriented towards the end disk 31 and the ring 13.

The central tube 73 extends at the center of the shell 70 and comprises an end 74 which extends slightly beyond the roof 71 and an opposite 75 which extends slightly beyond the cylindrical wall 72.

The shell 70 is fastened to the central shaft 41 by a bolt (not shown in FIG. 3) at the location of the end 74 which extends slightly beyond the roof 71. It is brought to the same stabilized voltage as the central shaft 41.

It will be noted that the ends of the filaments 62 are connected to the central shaft 41 at the end 74 of the central tube 73. The shell 70, the central shaft 41 and the filaments 62 are thus brought to the same predetermined potential.

From the other side of the shell 70, the first tubular part 32 enters the shell 70, and more particularly the cavity delimited by the circular wall 72 and the roof 71, to form a chicane for the stream of gas. This chicane protects the insulator 44 from soot and moisture.

The first tubular part 32 has a diameter greater than the central tube 73 which it encircles and the circular wall 72 has a diameter greater than the first tubular part 32 which it encircles.

The opposite end 75 of the central tube 73 is located substantially in the central opening 34 of the end disk 31 at the location of the insulator 44. As for the opposite end of the circular wall 72 to the end closed by the roof 71, this is located near the end disk 31.

It will be noted that the shell 70 is not in contact with the cylindrical component 30 except at the location of the central opening 34 with the insulator 44 located in the second tubular part 32 which electrically protects the shell 70 from the cylindrical component 30.

The central shaft 41 is connected to the circuit 80 supplying a negative stabilized high voltage. It passes via the internal passage of the cylindrical component 30 and is carried by the insulator 44, located in the second tubular part 33, which surrounds it.

The insulator 44 thus electrically protects the cylindrical component 30 from the central shaft 41.

It will be noted that the central shaft 41 passes via the internal passage of the cylindrical component 30 without being in contact with the cylindrical component 30 except with the insulator 44 which surrounds the central shaft 41.

The end plate (end disk 31 and ring 13) and the shell 70 each have a different predetermined potential. More generally here, the cylindrical component 30 and the ring 13 have a predetermined potential different from the predetermined potential of the shell 70.

The shell 70 is brought here to a negative potential comprised between −10 kV and −25 kV by the stabilized high voltage circuit 80 whereas the end plate, connected here to ground and more specifically to earth through the bolts 35, is brought here to a zero potential.

This potential difference between the end plate (more generally the cylindrical component 30) and the shell 70 creates a repulsive electric field in the neighborhood of the end plate, directed towards the passage for the gaseous medium laden with particles.

The potential difference is comprised between −10 kV and −25 kV here. Generally this potential difference is comprised between −35 kV et 0 kV.

The charged particles of soot are thus repelled from the end plate (end disk 31 and ring 13) in the direction of the passage. The deposit of soot particles on the end plate is thus avoided.

The soot particles arriving with a predetermined speed in the device 10 at the inlet 14 are thus repelled into the passage which makes it possible to avoid the deposit of soot particles on the end disk 31 and on the ring 13.

This avoids the formation of electric arcs on the end plate, which is responsible for a drop in effectiveness of the purification device 10. Avoided also is the stopping of the purification device 10 in order to clean the face of the end disk 31 and the ring 13 disposed facing opposite the passage.

In variants not shown:
the cylindrical component 30 is insulated from the casing 11 for example thanks to a circular insulator and the cylindrical component 30 is not connected to ground but to a circuit providing a stabilized high voltage able to bring the end plate to a predetermined potential different from 0 V, for example 5 kV.
the casing 11 and the metal meshes 51, 52 and 53 are not of circular shape but square instead;
the number of triangular arms 46 of the serrated plates 42 is different from sixteen, for example eight or four or any other suitable value;
the inlet of the electrostatic filtration chamber 20 by which the gaseous medium laden with particles enters is not the opening 14 but the opening 15 and the outlet of the electrostatic filtration chamber 20 by which the gaseous medium cleared of its particles is discharged is not the opening 15 but the opening 14;
there is no ring 13, the end disk 31 is fastened directly to the end of the casing 11 by means of the clamping ring 19;
the casing 11 is not formed by three cages 16, 17 and 18 but by a single cylindrical cage comprising the opening 14 and the opening 15;
the collecting structure 50 is not formed by three metal meshes 51, 52 and 53 but by a single metal mesh extending to each of the end plates;
the serrated plates 42 are not star-shaped but of twistable blade shape or of plate form having a central deflection surface on opposite sides, cut-outs forming the points 47 and the collecting structure 50 is not formed by circular metal meshes 51, 52 and 53 but by plates located on opposite sides, that is to say on the left and on the right, of the serrated plates 42;
the perforated washers 43 are replaced by perforated crowns comprising openings 66;
a high voltage transformer with two poles, that is to say one negative and the other positive, providing a voltage able to be set from 0 to 20000 volts is used, the negative pole capable of generating negative high voltage electricity between 0 and 20000 volts is connected to the central shaft 41 providing a corona effect by the intermediary of the serrated plates 42 and the filaments 62, the central shaft 41 being insulated by a dielectric ceramic, the positive pole being capable of generating positive high voltage electricity between 0 and 20000 is connected to the collecting structure 50 formed by a cartridge made from a metal wire mesh, the collecting structure 50 being insulated from the casing 11 by a circular insulator; it is to be noted that alternatively the positive pole may be connected to the central shaft and the negative pole may be connected to the collecting structure; a high voltage potential difference supply source is thereby generated so as to control the ozone concentration while having better effectiveness.
Upstream of the corona effect electrofilter the purification device 10 comprises another similar electrofilter in which enters clean air and leaves ionized air which is injected through the opening 14 in the corona effect electrofilter in order to be mixed with the particles of exhaust gases, and
the purification device 10 is not used for the purification of exhaust gases of an internal combustion engine but is used more particularly in an industrial installation, in a thermal power plant or in an incineration unit;

Numerous other variants are possible according to circumstances, and in this connection, it is to be noted that the invention is not limited to the examples described and shown.

1. Purification device for purifying a gaseous medium laden with particles comprising:
a casing (11) closed at ends thereof by an end plate (31) protected by a separate shell (70) surrounding one of the ends of an emitting structure and having a cavity oriented towards said end plate (31), said shell (70) being disposed inside said casing (11);
an electrostatic filtration chamber (20) having a passage for the gaseous medium laden with particles extending within said casing (11) between an inlet (14) for that medium into the chamber and an outlet (15) therefrom; said chamber comprising
an emitting structure (40) comprising serrated plates (42) forming points (47) directed towards a collecting structure (50); and
said collecting structure (50) being on opposite sides of said emitting structure (40) and configured to trap the particles contained in the gaseous medium;
wherein said end plate (31) and said shell (70) are each brought to a different predetermined potential so as to create a repulsive electric field in the neighborhood of said end plate (31), directed towards said passage.

2. The purification device according to claim 1, wherein said end plate (31) is brought to a zero potential and wherein said shell (70) is brought to a negative potential comprised between −10 KV and −25 KV.

3. The purification device according to claim 1, wherein the potential difference between said end plate (31) and said shell (70) is comprised between −35 KV and 0 KV.

4. The purification device according to claim 1, wherein said shell (70) has the shape of a bell formed by a circular wall (72) closed at one end by a roof (71).

5. The purification device according to claim 1, wherein said casing (11) is of circular shape and wherein said end plate is formed by an end disk (31) of a cylindrical component (30) comprising a first tubular part (32) and a second tubular part (33) projecting from said end disk (31), said first tubular part (32) and said second tubular part (33) having an opposite relationship to each other relative to said end disk (31), the first tubular part (32) being disposed inside said casing (11) and the second tubular part (33) being disposed outside said casing (11), said end disk (31) further comprising a central opening (34) forming an internal passage in said cylindrical component (30) between said first tubular part (32) and said second tubular part (33).

6. The purification device according to claim 5, characterized in that said first tubular part (32) enters said shell (70) to form a chicane (76) for the stream of gas.

7. The purification device according to claim 5, wherein said serrated plates (42) are carried by a central shaft (41) passing via said internal passage of said cylindrical component (30), said central shaft (41) being connected to a circuit supplying a stabilized high voltage (80) and being carried at each end of the central shaft by an insulator (44) surrounding said central shaft (41), said insulator (44) being disposed in said second tubular part (33) of said cylindrical component (30) to electrically protect said cylindrical component (30) from said central shaft (41).

8. The purification device according to claim 7, wherein said shell (70) is fastened to said central shaft (41) and wherein said shell (70) is brought to the same said stabilized voltage as said central shaft (41).

9. The purification device according to claim 7, wherein said stabilized voltage of said central shaft (41) is negative.

10. The purification device according to claim 1, wherein said emitting structure (40) comprises at least one electrically conducting filament (62) able to be brought to the potential of said emitting structure (40), said at least one filament (62) connecting together at least one said point (47) of at least two said serrated plates (42).

11. The purification device according to claim 10, wherein said at least one filament (62) connects a said point (47) of all said serrated plates (42).

12. The purification device according to claim 10, wherein said serrated plates (42) each comprise at least one opening (61) via which passes said at least one conducting filament (62).

13. The purification device according to claim 12, wherein said at least one filament (62) is electrically connected to a central shaft (41) carrying said serrated plates (42) and being connected to a circuit supplying a stabilized high voltage (80).

14. The purification device according to claim 10, wherein said emitting structure (40) comprises several said parallel filaments (62) surrounding said emitting structure (40) in a circular disposition.

15. The purification device according to claim 13, wherein said serrated plates (42) comprise as many said openings (61) as said filaments (62).

16. The purification device according to claim 1, wherein said serrated plates (42) are star-shaped, having a circular central support (45) provided at a periphery thereof with triangular arms (46) of which the end forms said points (47).

17. The purification device according to claim 1, wherein said serrated plates (42) alternate with perforated washers (43) of propeller shape.

18. The purification device according to claim 1, wherein said inlet (14) and said outlet (15) each form an angle with the axis of said passage generating a cyclonic effect in said passage.

19. The purification device according to claim 1, wherein said inlet (14) and said outlet (15) are diametrically opposite.

20. The purification device according to claim 1, characterized in that said collecting structure (50) extends to each of said end plates (31) of said casing (11).

21. A method for purifying exhaust gases of an internal combustion engine comprising providing the purification device of claim 1, and applying the purification device to the exhaust gases of the internal combustion engine.
